(19) United States
(12) Patent Application Publication
(10) Pub. No.: US 2013/0227217 A1
(43) Pub. Date: Aug. 29, 2013

(54) ARCHIVE SYSTEM AND PROCESSING METHOD

(71) Applicants: Hitachi-LG Data Storage, Inc., (US); Hitachi Consumer Electronics Co., Ltd., (US)

(72) Inventors: Shinichi SHIMODA, Yokohama (JP); Toshihiro KATO, Tokyo (JP); Hisahiro HAYASHI, Fujisawa (JP); Koji YAMASAKI, Yokohama (JP)

(73) Assignees: HITACHI CONSUMER ELECTRONICS CO., LTD., Tokyo (JP); HITACHI-LG DATA STORAGE, INC., Tokyo (JP)

(21) Appl. No.: 13/778,250

(22) Filed: Feb. 27, 2013

(30) Foreign Application Priority Data
Feb. 29, 2012 (JP) 2012-042750

(51) Int. Cl. G06F 12/00

(52) U.S. Cl. CPC G06F 12/00
USPC 711/114

(57) ABSTRACT

In a RAID group using a plurality of recording media readable and writable on both sides, a data configuration such that data on front sides of other disks may be held on back sides of respective double-sided disks is formed and managed, and data for restoration is created from readout data of other data disks than that with failure.

### BACKGROUND OF THE INVENTION

1. Field of the Invention

The present invention relates to an archive system of data and a processing method thereof.

2. Description of the Related Art

As a background technology of the technological field, there is Patent Document 1 (JP-A-2008-46986). Patent Document 1 discloses that, in data restoration processing at data disk failure in a RAID group using data disks having RAID configurations, “when a read request to the RAID group to which the data disk with failure belongs is received from a host computer, data is restored using data stored in another data disk belonging to the RAID group, and the restored data is transmitted to the host computer and written in a spare disk.”

In Patent Document 1, restoration control of the data disk with failure is disclosed. However, the case where the data disk is a recording medium readable and writable on both sides is not considered.

### SUMMARY OF THE INVENTION

Accordingly, a main object of the invention is to provide an archive system of data that efficiently handles data management and processing in a RAID group using a plurality of recording media readable and writable on both sides.

In order to solve the problem, for example, a configuration disclosed in “What is claimed is” is employed.

A data configuration is formed so that, on the back sides of double-sided disks as the respective recording media of the RAID group, data of the front sides of other disks may be held, and processing of management and control is performed.

According to the invention, there is provided an archive system of data that can easily prepare write data for both sides of a data disk as a recording medium with failure in a RAID group using a plurality of the recording media readable and writable on both sides.

The other problems, configurations, and advantages than those described as above will be made clear by the following explanation of embodiments.

### BRIEF DESCRIPTION OF THE DRAWINGS

FIG. 1 is a block diagram showing a configuration of a data archive system.

FIG. 2 is a flowchart of processing performed when data is written and recorded in a recording medium.

FIGS. 3A to 3C are explanatory diagrams of RAID processing of data.

FIG. 4 is an explanatory diagram of a configuration of data recorded in the recording media.

FIGS. 5A and 5B are explanatory diagrams of a comparison in difference between configurations of data recorded in the recording media.

FIG. 6 shows an information table of the recording media.

FIG. 7 is a flowchart of processing performed when readout processing of data from the recording medium is performed.

FIG. 8 is a flowchart of processing performed when disk data of the recording medium is restored.

FIG. 9 is an explanatory diagram of restoration processing of disk data of the recording medium.

FIG. 10 is a block diagram showing a configuration of an archive system having archive libraries.

### DETAILED DESCRIPTION OF THE EMBODIMENTS

As below, an embodiment will be explained using the drawings.

### Embodiment 1

Embodiment 1 is an embodiment, in an archive system in which an archive library having drives performs reading and writing operation according to a command of an archive server, when data is handled in RAID (Redundant Arrays of Inexpensive Disks) processing using optical discs readable and writable on both sides as recording media in the drives of the archive library.

The archive library is used for backup for the purpose of protection of data recorded in the archive server, a disk array device or the like, or archive for the purpose of long-term saving and safe storage of the data. Further, RAID is a technology of managing recording devices (hard disks or the like) collectively as one device and recording data in the recording devices in a distributed manner (there are seven types from RAID 0 to RAID 6 depending on the method of distribution), and thereby, realizing faster operation and improvement in fault tolerance. In this specification, the group of recording devices, recording media, pieces of data handled in the RAID processing will be collectively referred to as “RAID group”.

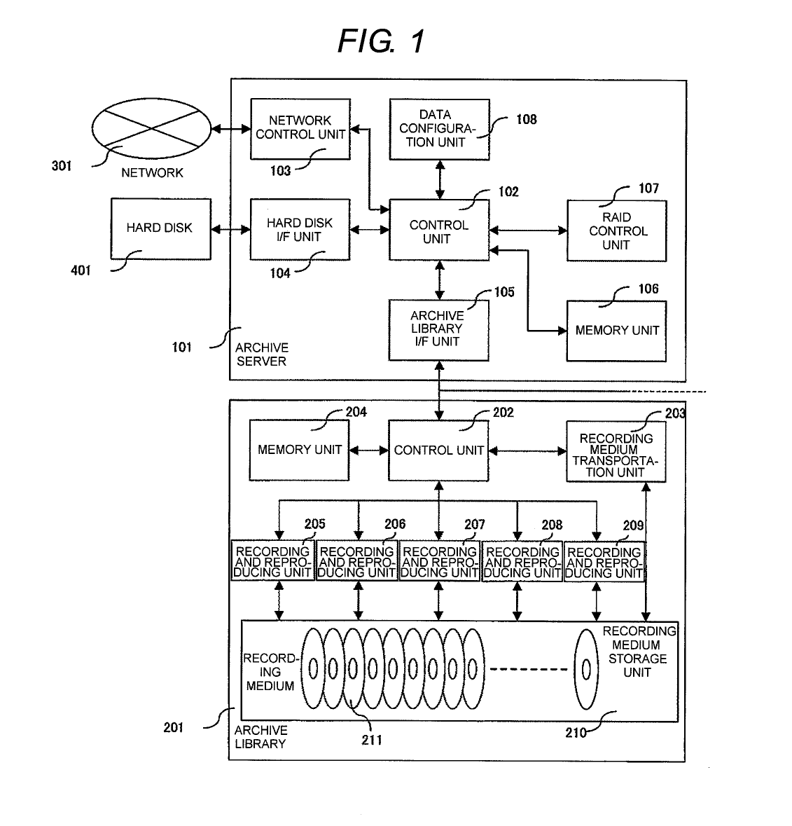

FIG. 1 is a block diagram showing a configuration of the archive system.

An archive server 101 provides service centered on recording and reproduction of data with respect to an archive library 201 connected thereto, and performs recording and reproduction of data with respect to a hard disk 401 and transmission and reception and management of data via a network 301.

A control unit 102 of the archive server 101 records data received from the network 301 via a network control unit 103 in the hard disk 401 via a hard disk I/F (interface) unit 104 at data recording. Alternatively, the control unit controls the archive library 201 via an archive library I/F (interface) unit 105 and records data in a recording medium 211 in the archive library 201.

At data reproduction, the control unit reads out data from the hard disk 401 via the hard disk I/F unit 104, and transmits the readout data to the network 301 via the network control unit 103. Or, the control unit controls the archive library 201 via the archive library I/F unit 105, reproduces data from the recording medium 211 in the archive library 201, receives the reproduced data, and transmits the received data to the network 301 via the network control unit 103. Or, the control unit appropriately processes, records, and manages various information received from the archive library 201 or reproduces the information, determines a control policy based on the reproduced information, and performs actual control.

The archive server 101 controls the archive library through communication with a control unit 202 built in the archive library 201, controls the hard disk 401, and performs recording and reproduction of data and data management such as data transmission and reception via the network 301. The hard disk 401 is controlled by the archive server 101 to accumulate data sent from the network 301. Further, the hard disk 401 may include one or some hard disks 401. Or, a disk array device including some hard disks may be employed.

In a memory unit 106, programs and various information for controlling the control unit 102 of the server 101 are recorded. The archive library I/F unit 105 performs control on data transmission and reception between the control unit 202 of the archive library 201 and the control unit 102 of the archive server 101.

A RAID control unit 107 performs RAID processing of data represented by RAID 5 and RAID 6 on the data from the control unit 102 and data processing of adding data that can be error-corrected such as parity data and dividing and creating data groups. Alternatively, the RAID control unit performs processing of enabling handling of RAID data groups read out from the archive library collectively as one piece of data.

A data configuration unit 108 performs processing of determining where of which recording medium 211 of the archive library 201 to record data created by the control unit 102 and the RAID control unit 107. Alternatively, the data configuration unit performs processing of determining where of which recording medium 211 of the archive library 201 data to be read out exists.

Note that one library device is connected to one archive library I/F unit 105 in the drawing, however, a plurality of library devices may be used as shown in FIG. 10 such that the plurality of library devices are connected via a network, for example. The hard disk I/F unit 104 performs data transfer compliant to standards such as SATA to the hard disk 401. The network control unit 103 performs control on data transmission and reception between the network 301 and the control unit 102 of the archive server 101.

The configuration example of the archive server of the archive system is as described above.

At recording, the archive library 201 performs processing of inputting the data received from the network 301 and the data accumulated in the hard disk 401 via the archive server 101 and recording the data in the recording medium 211. At reproducing, the archive library reproduces the data from the recording medium 211, and sends the data to the network 301 or accumulates the data in the hard disk 401 via the archive server 101.

The recording medium 211 is an optical disk represented by a DVD-RAM (Digital Versatile Disk Random Access Memory), for example. Further, regarding the recording medium 211, recording and reproduction can be performed on both the front side and the back side. Furthermore, the recording medium 211 may be a recording medium such as a magnetooptical disk or hologram.

A plurality of the recording media 211 are stored within a recording medium storage unit 210. In FIG. 1, only one recording medium storage unit 210 is shown, however, a plurality of the units may be built in the archive library 201 and the units may be used differently according to needs such that one may be used as an unrecorded recording medium storage unit and the other may be used as a recorded recording medium storage unit, for example. Obviously, the interior of the recording medium storage unit 210 may be partitioned into an unrecorded recording medium storage region and a recorded recording medium storage region.

At data recording, the recording medium 211 is taken out from the recording medium storage unit 210 by a recording medium transportation unit 203, and loaded in a recording and reproducing unit 205 to 209, and, after data recording is ended, returned to the recording medium storage unit 210 by the recording medium transportation unit 203. On the other hand, at data reproduction, the recording medium 211 is taken out from the recording medium storage unit 210 by the recording medium transportation unit 203, and loaded in the recording and reproducing unit 205 to 209, data is reproduced, and, after data reproduction is ended, returned to the recording medium storage unit 210 by the recording medium transportation unit 203.

The recording medium storage unit 210 contains location information for specifying the location of the recording medium, and the recording medium transportation unit specifies the recording medium based on the location information designated from the control unit.

The recording and reproducing units 205 to 209 are controlled by the control unit 202 of the archive library to perform recording of data in the recording media 211 or reproduction of the data from the recording media 211. In the case where the recording media 211 are optical disks, the recording and reproducing units 205 to 209 are optical disk drives and recording in the optical disks and data reproduction from the optical disks can be performed.

In FIG. 1, only five recording and reproducing units 205 and 209 are shown, however, more units may be employed and two or more of them may be built in the archive library 201.

The recording medium transportation unit 203 is controlled by the control unit 202 of the archive library 201 to take out the recording media 211 from the recording medium storage unit 210, transports and loads them in the recording and reproducing units 205 to 209. Alternatively, the recording medium transportation unit receives the recording media 211 from the recording and reproducing units 205 to 209, transports and stores them in the recording medium storage unit 210. In this regard, when recording or reproduction of the front side is performed according to the command of the control unit 202 of the library device, the recording medium transportation unit loads the recording medium in the recording and reproducing unit so that the front surface may be recorded or reproduced, and, when recording or reproduction of the back side is performed, loads the recording medium in the recording and reproducing unit so that the back surface may be recorded or reproduced.

The control unit 202 of the archive library 201 controls the recording medium transportation unit 203 according to a request from the archive server 101, selects the desired recording medium from the plurality of recording media 211 stored in the recording medium storage unit 210, and sends it to the recording and reproducing unit 205 to 209. Further, the control unit controls the recording medium transportation unit 203 to receive the recording medium 211 from the recording and reproducing unit 205 to 209, and stores the recording medium in a predetermined location within the recording medium storage unit 210. 204 denotes a memory unit and various programs and information are recorded therein, and, for example, programs and setting information for controlling the control unit 202 of the archive library 201 are recorded in the memory unit 106.

The configuration example of the archive library of the archive system is as described above.

In the archive system shown by the above described embodiment configuration, in the RAID group using recording media readable and writable on both sides, data writing, data readout, and data restoration processing to another new disk at readout failure will be described in detail by showing flowcharts etc.

First, data writing processing will be explained in detail using a flowchart in FIG. 2 and FIGS. 1 and 3A to 6. The archive server 101 retrieves data from the network 301 and the hard disk 401 in the control unit 102 via the network control unit 103 and the hard disk I/F unit 104, and starts recording processing of data in the archive library 201 (S101). First, the control unit 102 communicates with the archive library via the data library I/F unit 105, and determines the recording and reproducing units 205 to 209 to be used (S102). The control unit commands load of the recording media 211 in the plural recording and reproducing units 205 to 209, and allows execution of preparation of the recording media (S103).

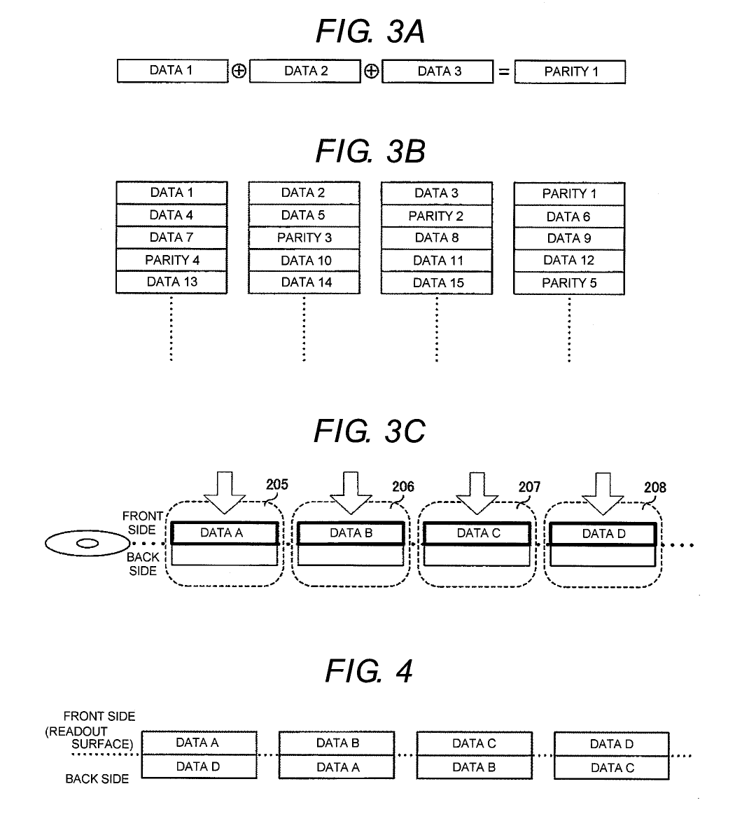

Then, the control unit 102 performs RAID processing of the input write data in the RAID control unit 107 (S104). Obviously, the step of the RAID processing and the above described step of preparing the recording media may be performed in the reverse order or at the same time. The RAID processing will be briefly described using FIGS. 3A to 3C. FIGS. 3A to 3C show processing of data to be written in the recording media 211 mounted on the recording and reproducing units 205 to 209 of the archive library 201 performed by the control unit 102 and the RAID control unit 107 of the archive server 101. In this example, regarding the recording and reproducing units determined at the step (S102), recording of the recording media is performed using four recording and reproducing units 205 to 208. When data is written in disks using the recording method of RAID 5, the control unit 102 performs processing of data sorting of finely sorting data in the respective recording media in certain units of data volume like data 1 to 3 and parity 1 and adding one piece of data in a row as parity data that can be used for parity check of the other data, in the RAID control unit 107 as shown in FIG. 3A. FIG. 3A computes data 1 to 3, and creates parity 1 of error correction data. By adding this parity data as redundant error correction data to the record data, a rebuild function of RAID that, if it becomes impossible to read out data in one recording medium due to failure, may restore the data that can not be read out from the other data is realized. The rebuild function of RAID refers to processing of restoring data recorded in the recording medium with failure based on the data recorded in the other recording medium. The first row of FIG. 3B is data sorted in FIG. 3A. As described above, data sorting is continuously processed, and data sorted as shown in FIG. 3B are written and recorded on the front sides of the recording media 211 of the respective recording and reproducing units 205 to 208 as data A to D, respectively, as shown in FIG. 3C. In this example, the number of recording and reproducing units for use is four, however, may be two or more. Further, in this example, the data arrangement is shown by RAID 5, however, RAID 4 or RAID 6 may be applied thereto.

After data is recorded on the front sides of the recording media (S105), the control unit 102 and the data configuration unit 108 determine a data configuration as assignment of data on the back sides with respect to the data on the front sides of the respective recording media (S106), and execute processing of mirroring (S107). Obviously, the step of determining the data configuration (S106) may be performed immediately after the step of RAID processing of data (S104). FIG. 4 shows a data configuration when the data configuration of data on the front sides and data on the back sides of the recording media 211 mounted on the recording and reproducing units 205 to 208 of the archive library 201 is determined and data is written therein by the control unit 102 and the data configuration unit 108 of the archive server 101. As shown in FIG. 4, in the data configuration unit 108, the data configuration is determined not to be a configuration in which the same data as the data on the front sides are provided on the back sides as data for mirroring, but to hold data on the front sides of other disks forming the RAID group on the back sides as data for mirroring. The risk of data loss is reduced by RAID, however, holding the data on back sides as mirroring data is for the purpose of further avoidance of the risk of data loss of important data. Further, if the mirroring data is saved in another disk not belonging to the RAID group, the number of disks to be managed with respect to the data is increased, the management becomes complex, and the number of disks is not reduced. Accordingly, the mirroring data is saved using the back sides of the disks forming the RAID group.

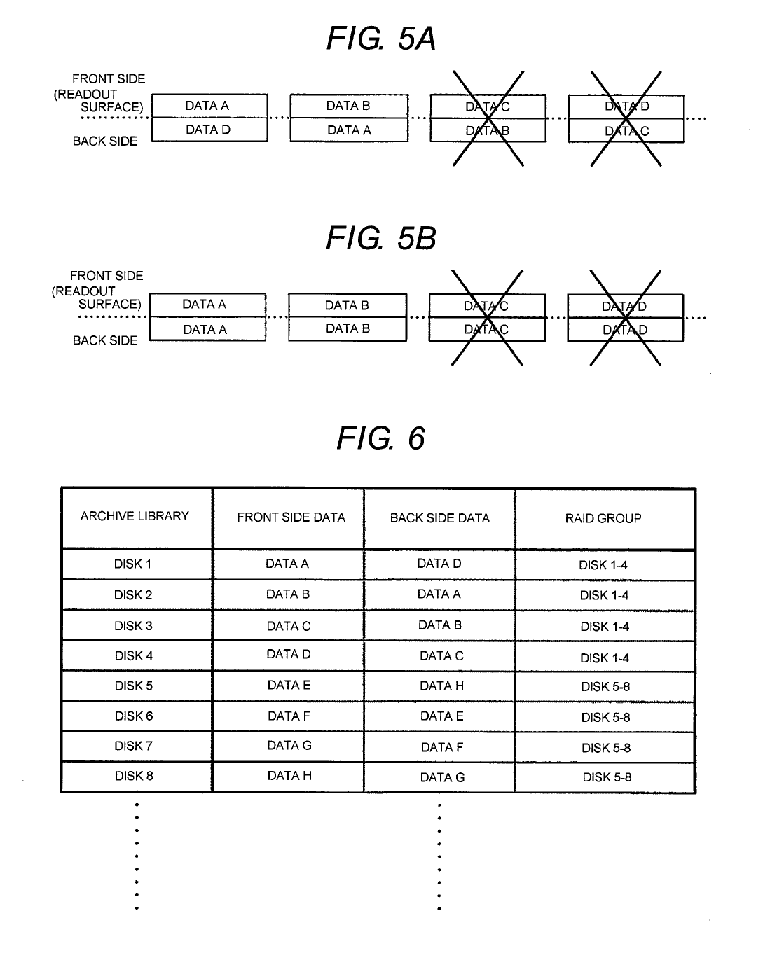

The reason that the configuration in which the mirroring data same as the data on the front sides are provided on the back sides is not employed, but the data on the front sides of the other disks forming the RAID group is held on the back sides as the mirroring data will be explained using FIGS. 5A and 5B. FIG. 5A shows a data configuration of the embodiment of the invention, and FIG. 5B shows a data configuration formed by simply mirroring the data on front sides on the back sides. When the recording medium is an optical disk, data may be damaged and lost due to breakage of the disk or the like. Further, in the case of a double-sided disk, data exists in physically near locations and the data may be damaged and lost on both sides depending on the breakage condition. As shown in FIG. 5B of RAID 5 of the embodiment, for example, even when data is written using the recording method of RAID 5 and one data loss is restored, if two pieces of data of a disk with data C and data of a disk with data D are broken and lost, it is impossible to restore data from the remaining data A and data B. When the data on the front sides of the other disks forming the RAID group are held on the back sides as mirroring data as shown in FIG. 5A, three pieces of data A, B, C are not damaged together with the data on the back sides and the restoration of data C can be performed using the rebuild function of RAID. Accordingly, the data configuration as shown in FIG. 5A is a data configuration having an advantage of preventing data loss of important data recorded in the double-sided disk and an effective advantage for the smaller number of disks.

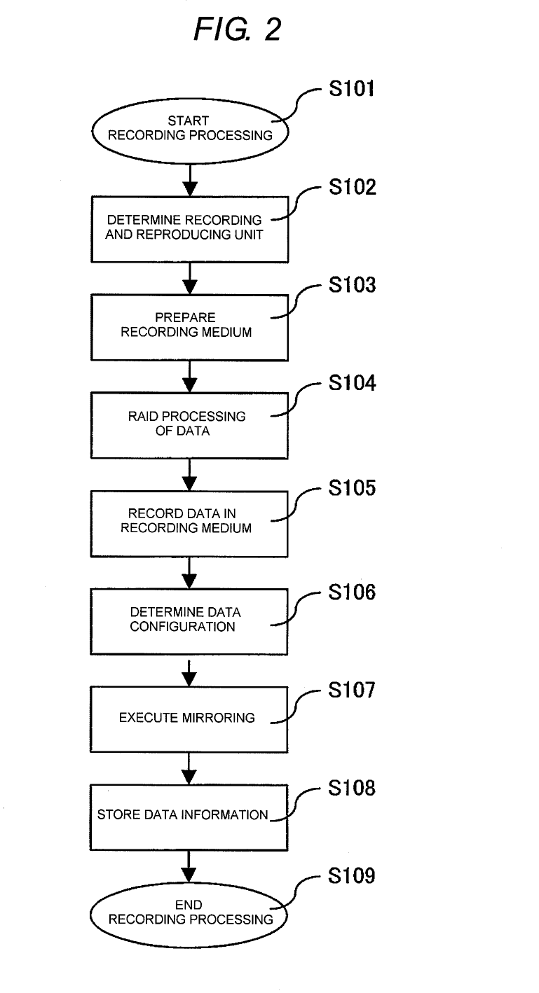

As described above, after the data configuration is determined at step 106 (S106) in FIG. 2, the recording media of the recording and reproducing units 205 to 208 are reversed and data is written and recorded in the determined data configuration on the back sides, and thereby, processing of mirroring is executed (S107). Finally, data information of the data configuration recorded on both sides of the recording media are recorded in the memory unit 106 of the archive server 101 (S108), and the recording processing is ended (S109). FIG. 6 shows an example of the data information recorded in the memory unit 106. As shown in FIG. 6, on each one double-sided disk as the recording medium 211 of the archive library 201, front side data, back side data, and disk information of the RAID group forming the RAID configuration at recording are held. By referring to this, advantages that on which side of which disk forming the RAID group mirroring data is recorded may be grasped and processing at data restoration becomes easier may be obtained.

As described above, data is formed so that the data on the front sides of the other disks forming the RAID group is held on the back sides as the mirroring data, the data is recorded and information of the data configuration is held in the memory unit, and thereby, the risk of loss of important data may be reduced and the number of disks to be handled may be reduced.

Further, even in the case where the double-sided disk configuration for recording data is employed and the disk information is held as described above, and thereby, an error occurs at data readout and data for both sides must be restored in a new disk, readout processing is not hindered, but processing of data restoration can be easily performed. This will be explained as below.

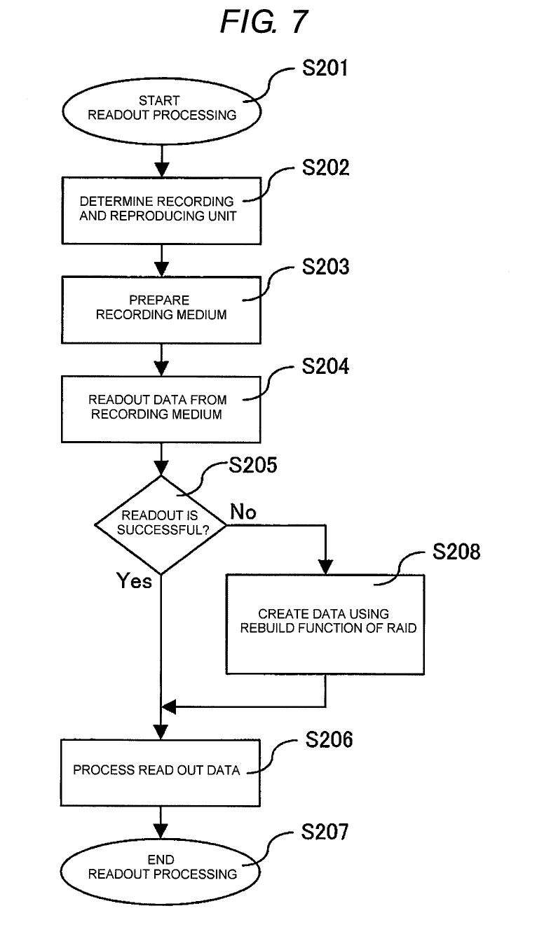

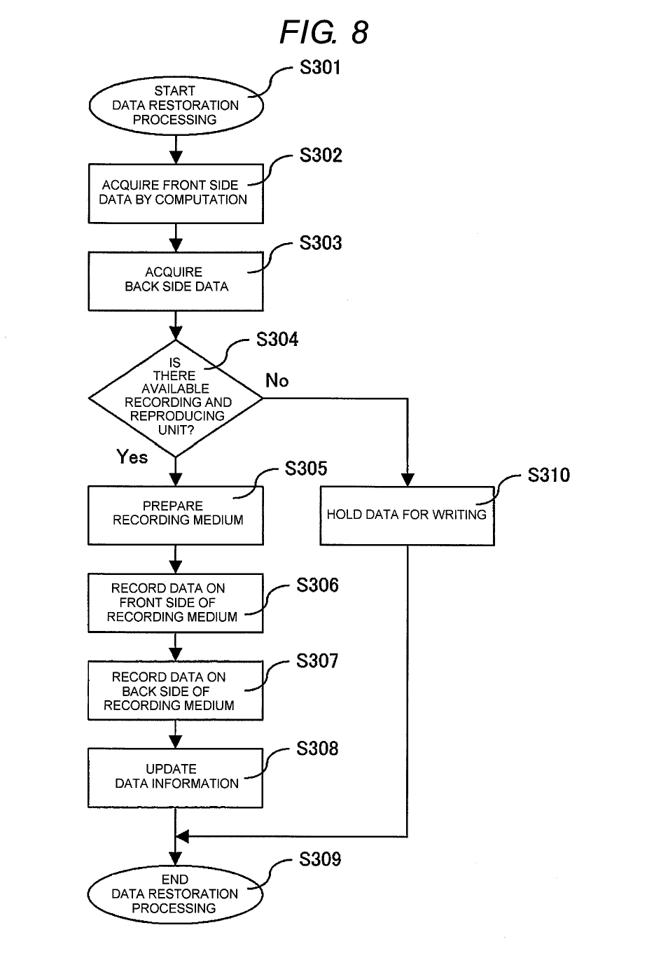

First, a processing procedure at readout of recorded data will be briefly explained. FIG. 7 shows an example of a flowchart of processing performed when readout processing of data from the recording medium is performed.

Readout of data is started (S201), the control unit 102 of the archive server 101 communicates with the control unit 202 of the archive library 201 and prepares the recording and reproducing units 205 to 209 for reading in corresponding data (S202). Then, according to the information stored in the memory unit 106 as shown in FIG. 6, the disks as the recording media 211 in which data is stored and the disks of the RAID group are loaded in the recording and reproducing units using the recording medium transportation unit 203, and data readout is enabled (S203). Then, the corresponding data is read out from the recording media (S204). Data readout is determined by the readout processing (S205), and, if the data readout is successful, the read out data is processed (S206) and the readout processing is ended (S207). If the data readout is unsuccessful, the corresponding data is computed from the data of the other disks of the RAID group and the data is acquired, and the readout processing is continued (S208). As described in the explanation at recording processing of data, for example, the data processed by RAID 5 contains error correction data, and thus, if it becomes impossible to read one disk, the data of the unreadable disk can be reproduced by recovery computation of the data based on the other disk data.

The readout-processed data as described above is output to the request source (S206), and the readout processing is ended (S207).

At step 205 (S205) in FIG. 7, the processing procedure of the data restoration processing when a readout error occurs in the middle of the readout processing will be explained in detail using FIG. 8.

FIG. 8 is a flowchart showing an example of the processing procedure of the data restoration processing.

The control unit 102 of the archive server 101 starts data restoration processing if the unit determines that restoration processing of data in the recording medium of the archive library is necessary (S301).

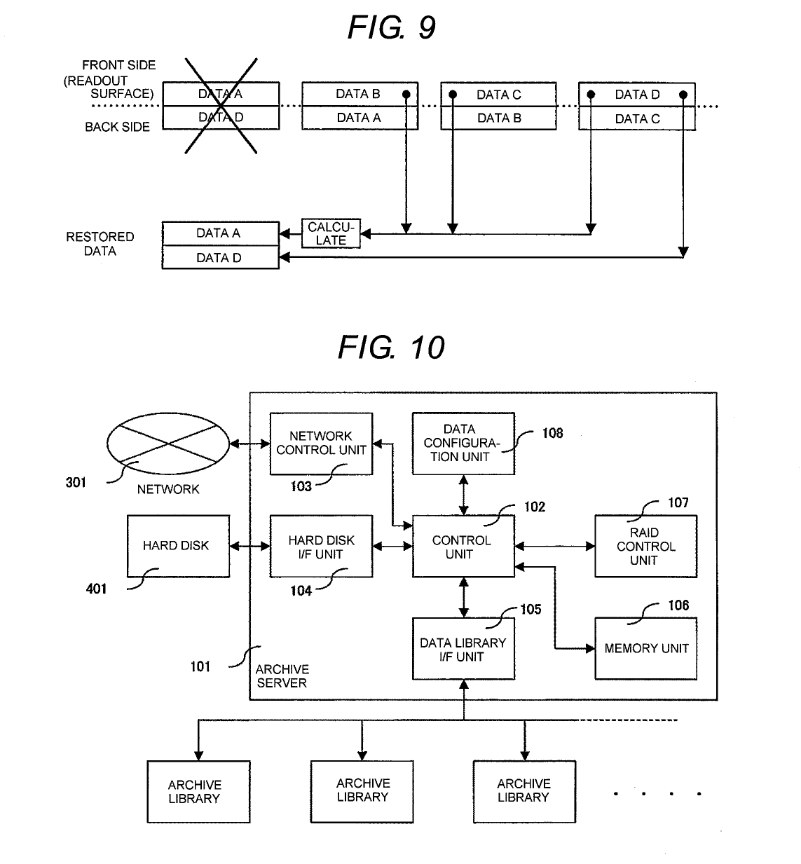

The data on the front side to be restored is acquired by computation (S302), and the data on the back side to be restored is acquired from data of another disk of the RAID group (S303). Obviously, the steps of data acquisition on the front side and the back side may be performed in the reverse order or at the same time. FIG. 9 is a diagram for explanation of processing of data to be restored. As described above, data on the front side and the back side are different as shown in the drawing on the double-sided disk as the recording medium. For example, if it becomes impossible to read out the disk with data A on the front side and data D on the back side for some reason, the data on the front side of the data to be restored may be computed and obtained using the front side data of the other disk of the RAID group using the rebuilt function of RAID. On the other hand, the data on the back side of the data to be restored is the same as the data of one of the other disks of the RAID group, and the disk containing the data may be determined by referring to the data information stored in the memory unit 106 as shown in FIG. 6 and this may be obtained as the back side data for restoration as it is. As known from FIG. 9, all of the data used for acquisition may be prepared from the data on the front surfaces of the RAID group. Thereby, the data on both front and back sides to be restored may be prepared with the load condition of the disks kept (the readout condition kept), and, even when it is impossible to exchange or reverse the disks in the middle of data readout, data for both front and back sides for creation of a spare disk of the disk in poor condition of data readout maybe prepared. That is, even during continuous execution of the data readout procedure in FIG. 7 of reading out data from the archive library, processing of data restoration procedure in FIG. 8 may be performed in parallel.

The control unit 102 of the archive server determines whether or not the recording and reproducing units to perform processing of recording the data prepared as above in the recording media are available (S304), if no unit is available, the data for writing is held (S310) and the data restoration processing is ended. In this case, when the recording and reproducing unit becomes available afterward, data restoration is performed by performing processing of writing the held data for writing in a disk as a new recording medium. If the recording and reproducing unit such as the recording and reproducing unit 209 is available in the above described embodiment, the recording medium 211 is loaded in the recording and reproducing unit 209 using the recording medium transportation unit 203 and prepared (S305), the front side data is recorded on the front side of the recording medium (S306). Subsequently, the recording medium 211 is reloaded using the recording medium transportation unit 203 so that recording may be performed on the back side, and the back side data is recorded on the back side of the recording medium (S307). Finally, the data information on the disk of the recording medium 211 on which recording has been finished is stored in the memory unit, the data information is updated, and the data restoration processing is ended (S309).

Note that, if there is no newly available recording and reproducing unit, by using the recording and reproducing unit in which the disk with the unreadable data is loaded, at step 304 (S304), determination that there is an available recording and reproducing unit may be made and writing and creation of a spare disk for data restoration may be performed. The data of the unreadable disk can be computed, read out, and output from the other disk of the RAID group, and, by the processing in this manner, the unreadable disk may be taken out and a new disk for data restoration may be loaded in the recording and reproducing unit instead and used for writing.

As described above, by controlling the processing of data restoration, even during data readout of the loaded RAID group, data restoration processing of the unreadable data disk to a spare disk may be performed in the disk load condition as it is.

Thus far, in the description of the double-sided disks as the recording media at data recording, data reproduction, data restoration, or the like, the front sides and back sides have been used for convenience, however, naturally, it is obvious that the reference of the front sides and the back sides may be reversed or there is no distinction between front and back and the sides may be regarded as one side and the other side.

As described above, in the archive system, by controlling the operation of the archive server and the archive library and processing the data configuration at recording to the double-sided disks as the recording media and processing of the information of the recorded data, the archive system and the processing method that may easily manage recording data and perform data restoration processing of the double-sided disk data of the recording media may be provided.

Note that the invention is not limited to the embodiment, but includes various modified examples. For example, the above described embodiment has been explained in detail for clear description of the invention, but the invention is not necessarily limited to the embodiment having all of the explained configurations. Further, a part of a configuration of an embodiment may be replaced by a configuration of another embodiment, and a configuration of an embodiment may be added to a configuration of another embodiment. Furthermore, regarding parts of the configurations of the embodiments, addition, deletion, replacement of other configurations may be made.

In addition, part or all of the respective configurations, functions, processing units, processing means, etc. may be realized using hardware by designing them as an integrated circuit, for example. Further, the respective configurations, functions, etc. may be realized using software by interpreting and executing programs for realizing the respective functions using a processor. Information of programs, tables, files, etc. for realizing the respective functions may be placed in a recording device such as a memory, hard disk, or SSD (Solid State Drive) or a recording medium such as an IC card, SD card, or DVD.

Furthermore, control lines and information lines considered to be necessary for explanation have been shown, and all of the control lines and information lines are not necessarily shown for products. In practice, it may be considered that almost all configurations are connected to one another.

What is claimed is:

1. An archive system of recording data in an archive library and reading out data of the archive library under control of an archive server,
the archive server including
a RAID control unit that divides data into a plurality of RAID groups,
a data configuration unit that determines assignment of data to be recorded on a front side and a back side of a recording medium,
a control unit that controls communication with the archive library and processing operation of data, and
a memory unit that stores information, and
the archive library including
a plurality of recording media having recording surfaces on both front and back sides,
a recording medium storage unit that stores the plurality of recording media,
a plurality of recording and reproducing units that record and reproduce data in the recording media,
a recording medium transportation unit that transports and passes the recording media between the recording medium storage unit and the recording and reproducing units,
a control unit that controls communication with the archive server and the recording medium transportation unit and the recording and reproducing units, and
a memory unit that stores information,
wherein the data configuration unit of the archive server forms a data configuration so that data on the front sides of the other recording media may be held on the back sides of the respective recording media of the RAID group.

2. The archive system according to claim 1, wherein the memory unit of the archive server holds and stores information on the recording media, data on the front sides and data on the back sides, recording media of the RAID group forming a RAID configuration at recording and data information.

3. The archive system according to claim 2, wherein the control unit of the archive server may determine the data on both front and back sides of one recording medium forming the RAID group from the data information held in the memory unit.

4. The archive system according to claim 3, wherein the control unit of the archive server obtains the data on both front and back sides of one recording medium forming the RAID group from front side data of another recording medium forming the RAID group by performing computation or read-in.

5. The archive system according to claim 4, wherein the control unit of the archive server performs, at data restoration of the data on both front and back sides of one recording medium forming the RAID group in a new recording medium, restoration processing using the recording and reproducing unit used by the one recording medium.

6. The archive system according to claim 4, wherein the control unit of the archive server performs processing of simultaneously executing readout processing of front side data of the recording medium forming the RAID group and restoration processing of the data on both front and back sides of one recording medium forming the RAID group.

7. A data processing method of recording data in a recording medium having recording surfaces on both front and back sides provided in an archive library under control of an archive server, comprising:
selecting one of a plurality of recording and reproducing units that record data provided in the archive library;
preparing the recording medium;
performing RAID processing of data to be recorded;
recording the data in the recording medium;
constructing a data configuration on both front and back sides of the recording medium;
performing mirroring of data; and
storing data information on recorded data,
wherein, at the step of constructing the data configuration on both front and back sides of the recording medium, constructing the data configuration so that mirroring data on front sides of other disks may be held on the back sides of respective double-sided disks of a RAID group.

8. The data processing method according to claim 7, wherein, at the step of storing the data information of the recorded data, holding and storing information on the recording media, data on the front sides and data on the back sides, recording media of the RAID group forming a RAID configuration at recording and data information.

9. A data processing method of performing data restoration processing of the data of the archive library recorded by the data processing method according to claim 8 under control of the archive server, comprising:
acquiring front side data of the recording medium that holds data to be restored by computation;
acquiring back side data;
determining the available recording and reproducing unit of the archive library;
preparing the recording medium;
recording data on the front side of the recording medium;
recording data on the back side of the recording medium; and
storing data information of the recorded data,
wherein the step of acquiring the back side data acquires the data by determination from the data information held at the step of storing the data information of the recorded data.

10. The data processing method according to claim 9, wherein the step of acquiring the front side data of the recording medium by computation and the step of acquiring the back side data acquire the data from front side data of another recording medium forming the RAID group by performing computation or read-in.

11. The data processing method according to claim 10, wherein the step of determining the available recording and reproducing unit of the archive library determines that the recording and reproducing unit in which the recording medium having the data to be restored is loaded is used.
